(19) United States
(12) Patent Application Publication
(10) Pub. No.: US 2023/0014799 A1
(43) Pub. Date: Jan. 19, 2023

(54) WEDGE CHAMBER DEVICE FOR MOUNTING SAMPLES FOR MICROSCOPY

(71) Applicants: The University of North Carolina at Chapel Hill, Chapel Hill, NC (US); Mizar Imaging, LLC, Woods Hole, MA (US)

(72) Inventors: Paul Samuel Maddox, Chapel Hill, NC (US); Joel Carter Smith, East Falmouth, MA (US)

(21) Appl. No.: 17/782,843

(22) PCT Filed: Dec. 7, 2020
(86) PCT No.: PCT/US2020/063588

§ 371 Date: Jun. 6, 2022

Related U.S. Application Data
(60) Provisional application No. 62/944,760, filed on Dec. 6, 2019.

(51) Int. Cl. G01N 1/28; B01L 3/00

(52) U.S. Cl. CPC G01N 1/2813; B01L 3/50; B01L 2300/161; B01L 2400/0406

(57) ABSTRACT

Devices, systems, and methods for imaging samples. In some examples, a device includes at least two basins for holding a liquid medium, the at least two basins including a sample chamber and a reservoir. The device includes a wedge between the sample chamber and the reservoir, and the wedge protrudes into the sample chamber and defines a space between the wedge and a bottom of the sample chamber. The space is sized for holding one or more biological samples. The device is formed to define a flow channel between the sample chamber and the reservoir, and the flow channel is shaped to allow the passage of the liquid medium from the sample chamber and the reservoir and to block passage of the one or more biological samples between the sample chamber and the reservoir.

### PRIORITY CLAIM

This application claims the benefit of U.S. Provisional Patent Application Ser. No. 62/944,760 filed Dec. 6, 2019, the disclosure of which is incorporated herein by reference in its entirety.

### STATEMENT OF GOVERNMENT INTEREST

This invention was made with government support under Grant No. MCB-1652512 awarded by the National Science Foundation. The government has certain rights in the invention.

### TECHNICAL FIELD

This specification relates generally to mounting samples for microscopy and more particularly to wedge chamber devices for mounting samples.

### BACKGROUND

Light microscopy is a ubiquitous technology in the life sciences. Advances in light microscopy have repeatedly led to major breakthroughs; for example, the recent ability to perform long-term fluorescence based imaging has greatly increased the window of time a scientist can observe live samples. This technology has generated a secondary problem virtually all life scientists face: how to mount their living biological samples in such a way that they are held in place—firmly yet gently—against a cover slip so they can be imaged with an inverted light microscope.

### SUMMARY

This specification describes a device for holding a biological sample in place against a cover slip, firmly enough to hold the sample in place and gently enough to avoid damaging the sample. The device is easy to use. The device holds the samples in place to minimize their movement, an important consideration when imaging very small objects. And the device is gentle and preserves the sample intact and therefore allows it to continue functioning.

In some examples, a device includes at least two basins for holding a liquid medium, the at least two basins including a sample chamber and a reservoir. The device includes a wedge between the sample chamber and the reservoir, and the wedge protrudes into the sample chamber and defines a space between the wedge and a bottom of the sample chamber. The space is sized for holding one or more biological samples. The device is formed to define a flow channel between the sample chamber and the reservoir, and the flow channel is shaped to allow the passage of the liquid medium from the sample chamber and the reservoir and to block passage of the one or more biological samples between the sample chamber and the reservoir.

### BRIEF DESCRIPTION OF THE DRAWINGS

FIGS. 1A-1D illustrate an example device for mounting samples for microscopy;

FIG. 2 is a diagram show a cross-sectional view of the device to illustrate a wedge between the sample chamber and the reservoir;

FIG. 3 illustrates the flow of the liquid medium along the flow channel; and

FIG. 4 is a bottom of view of an example implementation of the device.

### DESCRIPTION

This specification describes a device for holding a biological sample in place against a cover slip, firmly enough to hold the sample in place and gently enough to avoid damaging the sample. The device is easy to use. The device holds the samples in place to minimize their movement, an important consideration when imaging very small objects. And the device is gentle and preserves the sample intact and therefore allows it to continue functioning.

The device is made of, for example, polystyrene or similar high grade plastic material or glass as is standard for chambers for mounting and culturing biological specimens and is fitted on the bottom with a glass or optical polymer cover slip.

The device has two separate basins, which are connected to each other by a narrow (0.1-50 um) space (the flow channel) between the polystyrene and the cover slip. Samples in an aqueous medium are loaded into the first chamber, called the sample chamber. There is also a wedge between the sample chamber and the flow channel. Medium flows through the flow channel and into the second chamber, called the reservoir. The flow channel is too narrow for biological specimens. Thus, as the medium flows from the sample chamber to the reservoir it creates a force on the biological specimens pushing them towards the flow channel until they become wedged in between the wedge and the cover slip. The result is the samples are pressed close to the cover slip, which is one objective. The rate of flow of the medium (and hence the force created by the flow) can be easily modified in a number of ways (see below) and therefore can be made to be as gentle as required by the scientist, which is another objective. Thus, the samples are held in place so they cannot move and disrupt microscopic imaging, and this is done in such a way as to preserve their integrity so that they continue their biological functions.

Factors that Affect/Modify Force Applied to Sample
1. Scientist-applied:
   a. Rate at which scientist adds medium to sample chamber
   b. Use of wicking materials such as sponges or wipes in the reservoir
2. Variations to the device
   a. Width of individual wells
   b. Dimensions of flow channel (thickness, length, width)
   c. Added features to the flow channel (ribs, capillaries)
   d. Angle and length of wedge
   e. Hydrophilic or hydrophobic coating in flow channel or sample chamber
   f. Different shape to the reservoir (short wall, high wall, no wall, capillaries)

Other Variations

1. Sample mounting chamber for smallest biological samples between ˜2 um and ˜40 um, such as yeast, hematopoietic cells, small embryos and organoids. flow channel=0.1-1 um

2. Sample mounting chamber for medium-sized biological samples between ˜30 um and ˜400 um, such as mouse embryos, drosophila embryos, whole C. elegans embryos and adults, large organoids, tissue explants. flow channel=5-15 um

3. Sample mounting chamber for large biological samples between ˜300 um and ˜1 mm, such as zebrafish larvae, Xenopus embryos, tissue explants. flow channel=20-50 um

4. Sample mounting chamber for a range of sizes.

The wedge extends for greater distance so larger samples can fit or the wedge has multiple angles for instance closer to the flow channel it is at a lower angle while further away it is at a higher angle. Flow channel=0.1-10 um

5. For floating, swimming or suspended samples.

A Ledge is added such that it hangs down from the front of the wedge. The wedge is at very low angles, for instance 1-7°. Samples are pipetted under the ledge. Medium is then added to the sample chamber and forces samples to become wedged. flow channel may be larger to accommodate faster flow/stronger force. Could be narrow wells to allow for stronger flow forces.

### Additional Benefits

1. Samples line up under the wedge. Samples within a given population tend to be the same size, for instance yeast cells for a given species may be 4.5-5 um in diameter with little variation outside that range. This means that as medium goes through the flow channel the wedge will trap the samples in roughly a line. This allows them to be easily found and systematically observed, scored, measured, assayed, etc.
2. Because samples line up they are more amenable to illumination by for instance lightsheet illumination from the side, as fewer specimens will block and be in the way of the illuminating light.
   a. Variation/embodiment: front of the sample chamber is made with high grade optical polymer, such as polystyrene, and has no bends, deformations, etc., ie, be flat and therefore optically neutral, and therefore allow illuminating light to pass unimpeded.

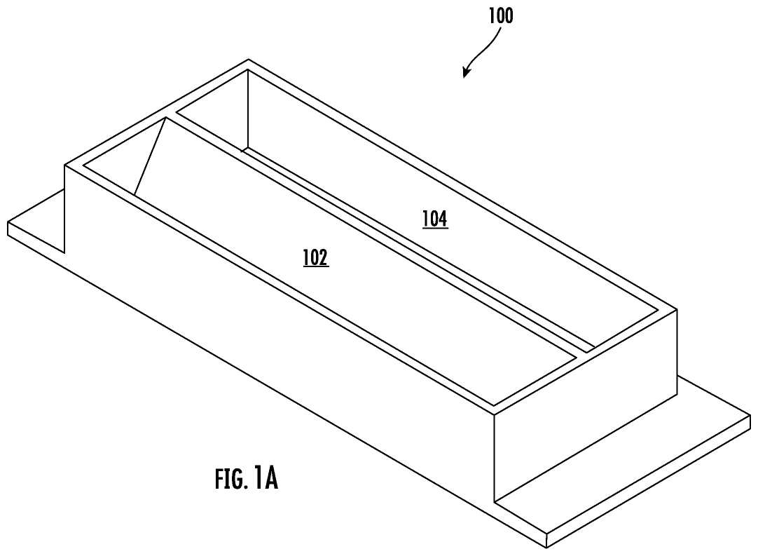

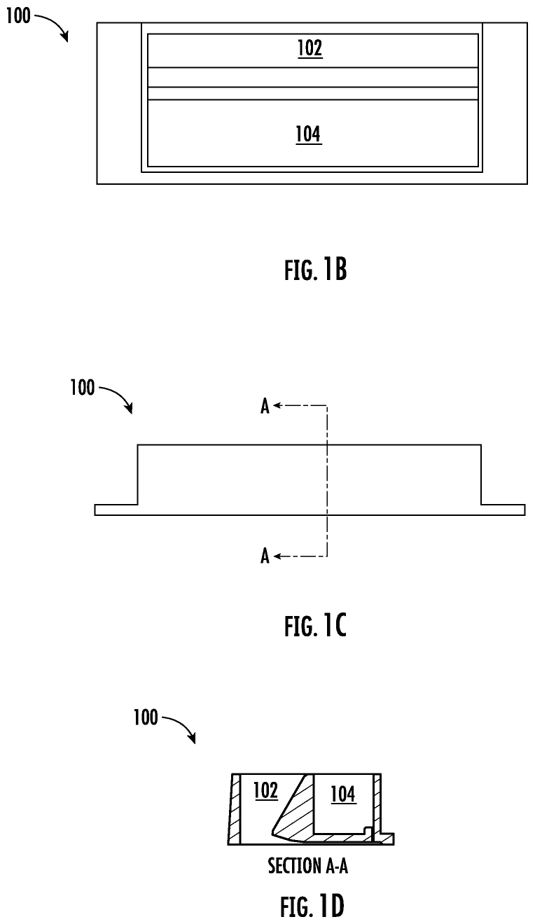

FIGS. 1A-1D illustrate an example device 100 for mounting samples for microscopy. The device includes at least two basins for holding a liquid medium. As shown in FIGS. 1A-1D, the device 100 includes a sample chamber 102 and a reservoir 104. FIG. 1A is a three dimensional view of the device 100. FIG. 1B is a top of the device 100. FIG. 1C is a side view of the device 100. FIG. 1D is a cross-sectional view of the device 100 along a cross-section A-A as illustrated in FIG. 1C.

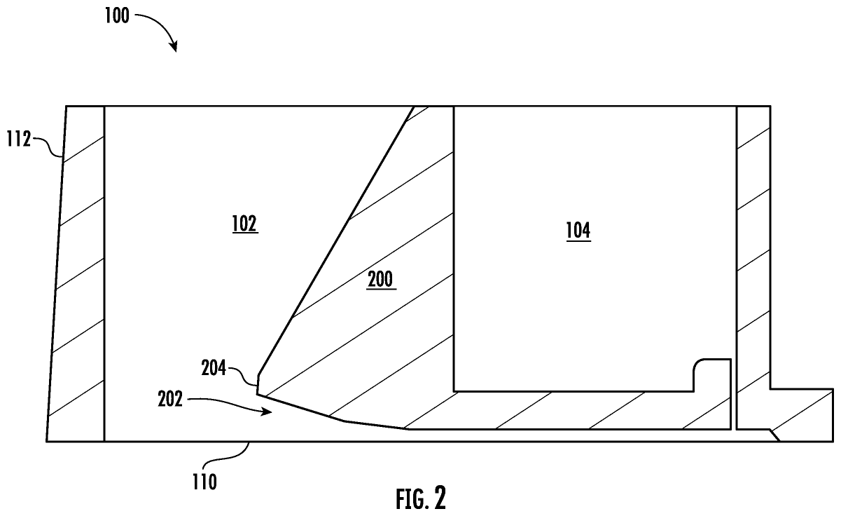

FIG. 2 is a diagram show a cross-sectional view of the device 100 to illustrate a wedge 200 between the sample chamber 102 and the reservoir 104. The wedge 200 protrudes into the sample chamber 102 and defines a space 202 between the wedge 200 and a bottom 110 of the sample chamber. The wedge 200 may be shaped, e.g., to include a protruding vertex 204 that protrudes into the sample chamber 102 and defines the space 202. The space 202 is sized for holding one or more biological samples or other appropriate types of samples.

The device 100 is formed to define a flow channel between the sample chamber 102 and the reservoir 104. The flow channel is shaped to allow the passage of the liquid medium from the sample chamber and the reservoir and to block passage of the one or more biological samples between the sample chamber and the reservoir.

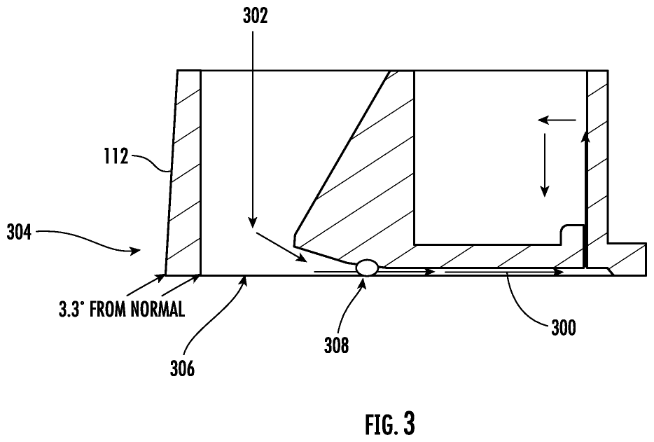

FIG. 3 illustrates the flow of the liquid medium 302 along the flow channel 300. FIG. 3 also shows an optional feature in that a front wall 112 of the sample chamber 102 may be at an angle (e.g., about 3 degrees) to the bottom 110 of the sample chamber 102. This can be useful, e.g., in certain illumination systems that produce a lightsheet 304. FIG. 3 shows the coverslip 306 and the sample 308 where it becomes wedged-in due the flow of the liquid medium 302.

The device can include various optional features to modify a rate of flow between the sample chamber 102 and the reservoir 104. For example, the reservoir 104 can include one or more wicking materials, or the flow channel can include one or more ribs or capillaries, or a hydrophobic or hydrophilic coating can be applied in the flow channel.

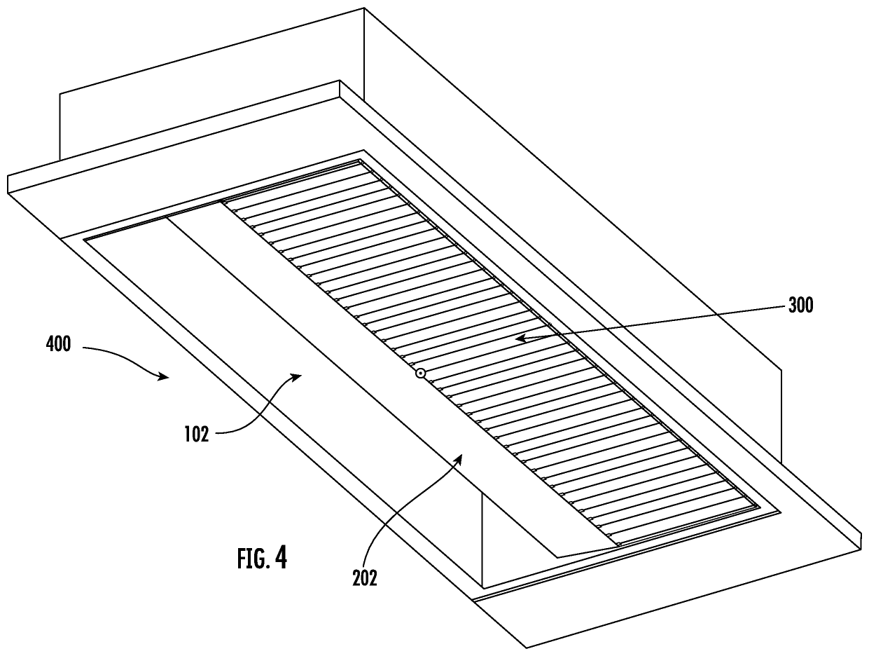

FIG. 4 is a bottom of view of an example implementation of the device. FIG. 4 illustrates an example of a flow channel 300 with ribs and the direction of an incoming lightsheet 400 for illuminating the sample for imaging by a microscope. FIG. 4 also shows the sample chamber 102 and the space 202 where samples get wedged in during operation.

The device as shown in FIG. 4 may work well with an inverted microscope since the sample can be imaged through the coverslip on the bottom, but the device can also be used with other microscopes.

Although specific examples and features have been described above, these examples and features are not intended to limit the scope of the present disclosure, even where only a single example is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed in this specification (either explicitly or implicitly), or any generalization of features disclosed, whether or not such features or generalizations mitigate any or all of the problems described in this specification. Accordingly, new claims may be formulated during prosecution of this application (or an application claiming priority to this application) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A device for mounting samples for microscopy, the device comprising:
at least two basins for holding a liquid medium, the at least two basins including a sample chamber and a reservoir;
a wedge between the sample chamber and the reservoir, wherein the wedge protrudes into the sample chamber and defines a space between the wedge and a bottom of the sample chamber, wherein the space is sized for holding one or more biological samples;
wherein the device is formed to define a flow channel between the sample chamber and the reservoir, and wherein the flow channel is shaped to allow the passage of the liquid medium from the sample chamber and the reservoir and to block passage of the one or more biological samples between the sample chamber and the reservoir.

2. The device of claim 1, wherein the wedge is shaped to include a protruding vertex that protrudes into the sample chamber and defines the space between the protruding vertex and the bottom of the sample chamber.

3. The device of claim 1, wherein the reservoir comprises one or more wicking materials configured to modify a flow rate of the liquid medium between the sample chamber and the reservoir.

4. The device of claim 1, wherein the device is formed to define one or more ribs or capillaries in the flow channel configured to modify a flow rate of the liquid medium between the sample chamber and the reservoir.

5. The device of claim 1, comprising a hydrophilic or hydrophobic coating in the flow channel or the sample chamber configured to modify a flow rate of the liquid medium between the sample chamber and the reservoir.

6. The device of claim 1, comprising a ledge hanging down from a front of the wedge.

7. The device of claim 1, wherein an optically transparent cover slip for a microscopy system forms the bottom of the sample chamber and the bottom of the device.

8. The device of claim 1, wherein the device is formed of plastic or glass.

9. The device of claim 1, wherein a front of the sample chamber is made with high grade optical polymer and is configured to be optically neutral to allow illuminating light to pass.

10. The device of claim 1, wherein the flow channel has a height between the bottom of the sample chamber and the wedge of between 0.1-50 um.

11. A system comprising:
a microscope;
an illumination system configured for illuminating a sample on the inverted microscope; and
a device for mounting the sample on the inverted microscope, the device comprising:
at least two basins for holding a liquid medium, the at least two basins including a sample chamber and a reservoir;
a wedge between the sample chamber and the reservoir, wherein the wedge protrudes into the sample chamber and defines a space between the wedge and a bottom of the sample chamber, wherein the space is sized for holding the sample;
wherein the device is formed to define a flow channel between the sample chamber and the reservoir, and wherein the flow channel is shaped to allow the passage of the liquid medium from the sample chamber and the reservoir and to block passage of the sample between the sample chamber and the reservoir.

12. The system of claim 11, wherein the microscope is an inverted microscope.

13. The system of claim 11, wherein the reservoir comprises one or more wicking materials configured to modify a flow rate of the liquid medium between the sample chamber and the reservoir.

14. The system of claim 11, wherein the device is formed to define one or more ribs or capillaries in the flow channel configured to modify a flow rate of the liquid medium between the sample chamber and the reservoir.

15. The system of claim 11, comprising a hydrophilic or hydrophobic coating in the flow channel or the sample chamber configured to modify a flow rate of the liquid medium between the sample chamber and the reservoir.

16. A method comprising:
flowing a liquid medium comprising a sample into a sample chamber of a device for mounting samples for microscopy, wherein the device comprises a reservoir and a wedge between the sample chamber and the reservoir, and wherein the device is formed to define a flow channel between the sample chamber and the reservoir, and wherein flowing the liquid medium causes the liquid medium to flow from the sample chamber to the reservoir and causes the sample to become wedged in a space between the wedge and a bottom of the sample chamber; and
imaging the sample in the device using an inverted microscope.

17. The method of claim 16, comprising illuminating the sample using an illumination system.

18. The method of claim 16, wherein the reservoir comprises one or more wicking materials configured to modify a flow rate of the liquid medium between the sample chamber and the reservoir.

19. The system of claim 16, wherein the device is formed to define one or more ribs or capillaries in the flow channel configured to modify a flow rate of the liquid medium between the sample chamber and the reservoir.

20. The system of claim 16, comprising a hydrophilic or hydrophobic coating in the flow channel or the sample chamber configured to modify a flow rate of the liquid medium between the sample chamber and the reservoir.
